(19) United States
(12) Patent Application Publication
(10) Pub. No.: US 2007/0002729 A1
(43) Pub. Date: Jan. 4, 2007

(54) Method for optimally deactivating inter-domain routes

(75) Inventor: Thomas Engel, Unterbiberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, München (DE)

(21) Appl. No.: 10/571,052

(22) PCT Filed: Aug. 24, 2004
(86) PCT No.: PCT/EP04/51882

§ 371 Date: Mar. 7, 2006

(30) Foreign Application Priority Data
Sep. 8, 2003 (DE) 103 41 336.7

(51) Int. Cl. H04J 1/16

(52) U.S. Cl. 370/216; 370/396

(57) ABSTRACT

The inventive method provides that the failure of a segment, which connects two autonomous systems, is communicated as a segment failure to affected autonomous systems. The autonomous systems informed of the segment failure then deactivate inter-domain routes containing the down segment. After restoring the segment, the routes containing the segment can be reactivated after the propagation of a corresponding message. The method can use conventional protocols, particularly the Border Gateway Protocol, by treating the down segment as a route that is made recognizable as a segment by means of a PATH ATTRIBUTE. In contrast to the conventional procedure within the framework of the Border Gateway Protocol, routes that can no longer be used do not need to be individually communicated. An efficient propagation of the information concerning the fault and an improved convergence of the routing information of the autonomous system, said routing information being changed thereupon, is thus achieved.

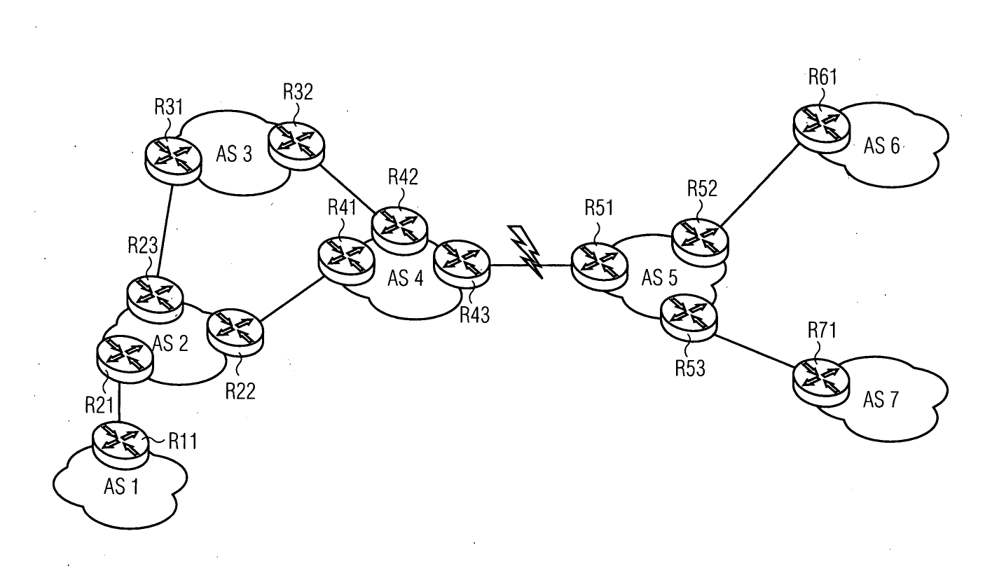

The invention relates to a method for shutting down inter-domain routes.

The invention lies within the field of internet technologies and more specifically within the field of routing methods in packet-oriented networks.

At present the convergence of speech and data networks is arguably the most important development in the field of networks. An important future scenario is that data, speech and video information will be transmitted via a packet-oriented network with newly developed network technologies ensuring adherence to requirement features for different classes of traffic. The future networks for different types of traffic will operate in a packet-oriented manner. Current development activities relate to the transmission of speech information via networks conventionally used for data traffic, primarily IP-based (Internet Protocol) networks.

To allow speech communication via packet networks, and in particular IP-based networks, of a quality which meets that of speech transmission via line-switched networks, quality parameters, such as the delay of data packets or the jitter, must be kept within tight limits. In speech transmission it is highly important to the quality of the service provided that the delay times do not significantly exceed 150 milliseconds. To achieve an appropriately short delay work is being done on improved routers and routing algorithms which should allow faster processing of the data packets.

In the case of routing via IP networks, a distinction is conventionally made between intra-domain and inter-domain routing. Data transmission via the internet conventionally involves different networks—sub-nets, domains or what are referred to as autonomous systems are frequently mentioned—of different network operators. The terms “autonomous system” and “inter-domain routing” will be used below for routing between autonomous systems. Routes along autonomous systems—also called inter-domain routes—will also simply be called “routes” below.

The network operators are responsible for routing within the autonomous systems which fall within their field of responsibility. Within these autonomous systems they have the freedom to adapt the procedure in routing as they wish as long as quality of service features can be maintained. The situation is different with inter-domain routing, i.e. with routing between different domains, in which different operators of autonomous systems come into contact with each other. Inter-domain routing is complicated by the fact that, on the one hand, optimal paths to the target via different autonomous systems should, as far as possible, be determined, but, on the other hand, the respective operators can apply local strategies which make a global calculation of optimal paths according to objective criteria difficult.

What are referred to as Exterior Gateway Protocols EGP are used for routing between different domains. At present Border Gateway Protocol Version 4 (Border Gateway Protocol is frequently shortened to BGP), described in more detail in the RFC (Request for Comments) 1771, is most commonly used in the internet. The Border Gateway Protocol is what is referred to as a Path Vector Protocol. A BGP instance (the expression “BGP speaker” is often found in English-language literature) is informed by its BGP neighbour about possible paths to targets to be reached via the respective BGP neighbour. Using likewise imparted properties of the paths (path attributes) the BGP instance determines the, from its local perspective, optimal path in each case to the targets that can be reached. Four types of message are exchanged between BGP instances within the framework of the BGP protocol, including what is referred to as an UPDATE message with which path information is propagated throughout the entire network and which allows routing to be optimised in accordance with the changes in reachability. Sending out update messages conventionally leads to an adjustment of path information in the case of all affected BGP instances of the network in the context of routing that is optimised in accordance with the locally prevailing information. In addition, what are referred to as keepalive or status confirmation messages, with which a BGP instance enlightens its BGP neighbours about its functional capability, also play a part. In the absence of these messages the BGP neighbours assume that the link to the BGP instance is defective.

The propagation of reachability information using the BGP protocol has the drawback that with frequent advertisements of change, considerable loading of the messages propagated via the network occurs for advertising the change and routing converges relatively slowly, i.e. the conversion of changes in the topology of the network into corresponding inter-domain routes is associated with significant convergence times.

The object of the invention is to disclose a method for optimised error recovery in inter-domain routing.

The object is achieved by a method according to claim 1.

According to the invention, the failure of a segment connecting two autonomous systems (for example a link between two routers respectively associated with one of the autonomous systems) is communicated by a router (for example a BGP speaker) of a first autonomous system to a second autonomous system. The second autonomous system thereupon shuts down the routes which contain the failed segment. Information about the failure of a segment can be propagated to all affected autonomous systems which then deactivate the corresponding routes. When the segment is returned to service, a corresponding message can be sent to the autonomous systems which have deactivated routes and thus reactivation of the routes can be brought about.

According to the current prior art, which is given by the BGP protocol, routes are disclosed by means of UPDATE messages and in the case of a fault are explicitly withdrawn by what are referred to as withdrawals (routes in the “WITHDRAWN ROUTES” field of UPDATE messages) or are implicitly withdrawn by the disclosure of a new route to the same target. A route consists in this case of two parts: a description of the IP addresses (IP: Internet Protocol) reachable therewith and a list of AS numbers which usually describes the AS path to the target network. In this case AS is an autonomous system. In the case of a faulty segment in a route, for example a faulty connection between two IP networks, all routes running via it must be explicitly withdrawn by means of withdrawals or be implicitly withdrawn by the disclosure of a new route. Usually explicit withdrawals are propagated from BGP instance to BGP instance, starting from the networks adjoining the faulty connection. If a BGP instance of a network located further away receives an UPDATE message with a withdrawal, and knows alternative routes to the same target, it chooses one of these alternatives as a new route and propagates this route instead of the withdrawal. However, as the BGP instance does not know the cause of the withdrawal, it frequently chooses a new route which while differing from the withdrawn route also contains the faulty segment. Consequently a changeover to faulty routes is effected until these routes are also withdrawn by wide UPDATE messages. Together with the MRAI (Minimum Route Advertisement Interval), a timer which regulates how fast route updates are forwarded, the changeover to faulty routes leads to long convergence times. Instead of the explicit withdrawal of all affected routes in the case of a faulty connection between two IP networks, according to the invention the faulty segment of the affected routes is disclosed from among the affected routes or autonomous systems. It is known that the convergence can take up to 15 minutes as in the case of withdrawal of a route it is not known where the problem is and frequently a changeover is firstly made to known alternative routes which contain the same faulty segment.

The new solution leads to significantly shorter convergence times. If in addition care had been taken that at least two different disjunct paths are known for each target AS, the availability can be significantly improved.

The quantity of information, which has to be forwarded in the event of a fault, is also considerably reduced by the solution according to the invention: only a message needs to be forwarded instead of a large number of routes. Owing to the size of routing tables, the quantity of routing information to be exchanged also nowadays constitutes a problem that needs to be taken seriously. As a result of the fact that considerably less information has to be exchanged with “segment withdrawals”, this information can be processed more efficiently and more quickly.

The invention also has the advantage that it can be achieved by way of the means provided by conventional protocols (especially the BGP protocol). For this purpose this segment, as hitherto, is described like a route but contains only two AS numbers. In the event of a fault this segment is forwarded like a withdrawal but with a marking to indicate that it is a segment and not a complete route, for example by means of a new “path attribute” which is used in accordance with the Requests for Comments [RFC2042] and [RFC1771]. The receiver of a segment withdrawal of this type thereupon treats all routes known to him which contain the faulty segment as if he had received a route withdrawal in this regard.

Moreover, if the faulty segment is available again (with faults of sufficiently short duration), all affected routes may similarly be returned to service by a “(segment withdrawal) withdrawal” or a retraction of the withdrawal of the segment. This retraction can also take place by means of an UPDATE message. The withdrawn routes can remain in the routing tables with the advice “Unavailable for a short time” until a timer has expired.

The invention will be described in more detail hereinafter in the context of an embodiment and with reference to a figure. The figure shows by way of example a combination of IP networks: AS1, AS2, . . . , AS7 are seven administratively independent IP networks which exchange IP traffic with each other via the illustrated border routers R11, R21, R22, R23, R31, R32, R41, R42, R43, R51, R52, R53, R61 and R71. Thus for example a customer connected to AS1 arrives at a www page of a server connected to AS7 via the route given by a sequence of autonomous systems (1, 2, 4, 5, 7).

If in the combination of IP networks illustrated in the figure, which for example represents a detail from the internet, the connection of AS5 to AS4 fails, the following routes of AS1:

(1, 2, 4, 5)
(1, 2, 4, 5, 6)
(1, 2, 4, 5, 7)

can be withdrawn with the segment withdrawal:
(4, 5)

and an intermittent changeover via AS2 to one of the following alternatives can be avoided:

(1, 2, 3, 4, 5)
(1, 2, 3, 4, 5, 6)
(1, 2, 3, 4, 5, 7)

i.e. all routes which contain the faulty AS sequence (4, 5) are withdrawn with a single message. If AS2 knows a further route to AS5 not illustrated in the figure, then AS2 would changeover to it directly.

1-12. (canceled)

13. A method for shutting down inter-domain routes, comprising:
establishing a failure of a segment connecting two autonomous systems by a router of a first autonomous system;
sending a message, which contains information relating to the failure of the segment, and by means of which the failed segment is disclosed to the second autonomous system, from the router to a second autonomous system; and
shutting down the inter-domain routes containing the segment by a router of the second autonomous system.

14. The method according to claim 13, wherein the message is sent directly from the router, or via one or more routers, to the second autonomous system.

15. The method according to claim 13, wherein the router of the second autonomous system sends a message that contains information relating to the failure of the segment to at least one further adjacent autonomous system.

16. The method according to claim 15, wherein the message is sent directly from the router of the second autonomous system, or via one or more further routers of the same autonomous system, to the further adjacent autonomous system.

17. The method according to claim 13, wherein a message that contains information relating to the failure of the segment is transmitted to all autonomous systems that comprise at least one route containing the segment for routing data packets.

18. The method according to claim 13, wherein when the segment is returned to service, a message is sent to an autonomous system that has shutdown inter-domain routes containing the segment, the message containing information on the fact that the segment has been returned to service.

19. The method according to claim 13, wherein when the segment is returned to service, a message is sent to all autonomous systems that shutdown inter-domain routes containing the segment and the message containing information on the fact that the segment has been returned to service.

20. The method according to claim 18, wherein at least one autonomous system that has been informed about the return to service of the segment returns the inter-domain routes containing the segment to service.

21. The method according to claim 13, wherein the message containing the information about the failure of the segment is transmitted by an UPDATE message of the Border Gateway Protocol.

22. The method according to claim 21, wherein the message containing the information about the return to service of the segment is transmitted by an UPDATE message of the Border Gateway Protocol.

23. The method according to claim 21, wherein the segment is transmitted in the field of the UPDATE message, which is provided per se for the transmission of routes, and specified by a PATH ATTRIBUTES parameter that a segment is involved.

24. The method according to claim 13, wherein the first and second autonomous systems are IP (Internet Protocol) networks.
